(19) United States
(12) Patent Application Publication
(10) Pub. No.: US 2008/0106074 A1
(43) Pub. Date: May 8, 2008

(54) Air Bag Module and Fastener

(75) Inventor: Brian C. Ford, Mt. Clemens, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: KEY SAFETY SYSTEMS, INC., Sterling Heights, MI (US)

(21) Appl. No.: 11/875,521

(22) Filed: Oct. 19, 2007

Related U.S. Application Data
(60) Provisional application No. 60/864,105, filed on Nov. 2, 2006.

(51) Int. Cl. B60R 21/20; A44B 21/00

(52) U.S. Cl. 280/728.2; 24/563

(57) ABSTRACT

A band clamp (50, 60, 70) for securing an inflator of an air bag module (300) to a mounting surface, the clamp having a band formed into a loop of diameter slightly larger than a diameter of the inflator enabling the band to be slipped over the inflator, the band including a fastener receiving opening (32) therethrough to receive a fastener (22) which is receivable into the mounting surface, the band further including a means for tightening (40) the band about the inflator, such tightening creating stress within the band which if uncompensated tends to enlarge the fastener receiving opening, the band clamp further including first means including a set of holes (58, 60) that are larger than the fastener receiving opening (32) for absorbing the stress to lessen the possible enlargement of the fastener receiving opening.

This application claims the benefit of U.S. Provisional Application 60/864,105, filed on Nov. 2, 2006. The disclosure of the above application is incorporated herein by reference.

### BACKGROUND AND SUMMARY OF THE INVENTION

The present invention relates to air bag systems and modules and ways to mount a cylindrical inflator within a housing of an air bag module. More particularly the invention relates to a band clamp for such an inflator.

FIGS. 1-3 illustrate a prior art band clamp 20 such as the one in my U.S. Pat. No. 6,669,226. A band clamp such as 20 includes a relatively narrow, threaded press stud or fastener 22 that is received in a sheet metal band 30; an upstanding projection 40 is often provided so that when crimped, tightens the clamp on the part to be secured such as an air bag inflator. Fastener 22 includes a large head 24, which includes a plurality of ribs 28 positioned radially on an undersurface of the head 24. The metal band 30 includes ends 36 and 38 each with a fastener receiving aperture 32 near a corresponding end. Both apertures 32 are sized to receive the threaded body 34 of fastener 22. The ends 36 and 38 are brought into contact and openings 32 aligned with each other and fastener 22 is received through both openings 32. The fastener 22 after being inserted through openings 32 is press fit or swaged to the sheet metal band 30. The ribs 28 dig into the metal of the band to provide a mechanism bond that resists torsional forces (torque-out resistance) applied to the fastener. For example, a properly designed band clamp will prevent the fastener 22 from rotating within the opening(s) 32 when a torsional force is applied to the fastener such as when a nut 56 is tightened on the fastener 22. If the fastener is torqued-out of the band it will slip and rotate and make it impossible to tighten the nut onto the fastener. A loose band, or fastener or nut is a source of unwanted noise in an air bag module and an annoyance to the occupant of the vehicle. The band clamp in the above patent also includes a projecting section 40; after the band clamp is fitted about the object to be secured in place, such as a cylindrical air bag inflator, a tool, such as pliers or other type of clamping or crimping mechanism is placed about the sides 42 and 44 of the projecting section 40. The tool squeezes the sides 40 and 42 thereby reducing the diameter of the band 30, causing the band clamp to become tightly fit about the inflator.

One of the advantages of the present invention is it allows for an increased torque-out resistance of the stud from the band. It can be shown that torque-out resistance reduces when opening 32 is stretched or distorted, which reduces the bond between the ribs and the band. When the band is stressed the opening 32 will often become oblong in shape. The condition may occur when the band is over tightened about the inflator or when the nut, which secures the band clamp to a housing, pulls on the fastener excessively thereby stressing the band

The present invention provides a band clamp with an increased torque-out resistance and solves the above problem through the addition of one or more holes located on the sides of the fastener opening 32; these additional holes are allowed to deform and stretch thereby protecting the fastener receiving hole from deforming. By introducing these extendable side holes the center fastener receiving opening 32 remains circular in shape. Accordingly the invention comprises: a band clamp for securing an inflator of an air bag module to a mounting surface, the clamp having a band formed into a loop of diameter slightly larger than a diameter of the inflator enabling the band to be slipped over the inflator, the band including a fastener receiving opening therethrough to receive a fastener which is receivable into the mounting surface, the band may further include a means for tightening the band about the inflator, such tightening creating stress within the band which if uncompensated tends to enlarge the fastener receiving opening, the band clamp further including first means for absorbing the stress to lessen the possible enlargement of the fastener receiving opening.

### BRIEF DESCRIPTION OF THE DRAWINGS

FIG. 1 illustrates a fastener used in a prior art band clamp.

FIG. 2 shows one type of band clamp with the fastener inserted within a band.

FIG. 3 illustrates the band of the band clamp.

FIGS. 4, 4a, 5, 6 and 6a illustrate alternate bands in accordance with the present invention.

FIG. 7 illustrates the use of a single band of the present invention about an air bag inflator.

FIG. 8 illustrates the use of two bands about another air bag inflator.

FIG. 9 is an orthogonal view of an air bag module housing with an inflator therein.

FIG. 10 shows another view of an air bag module housing.

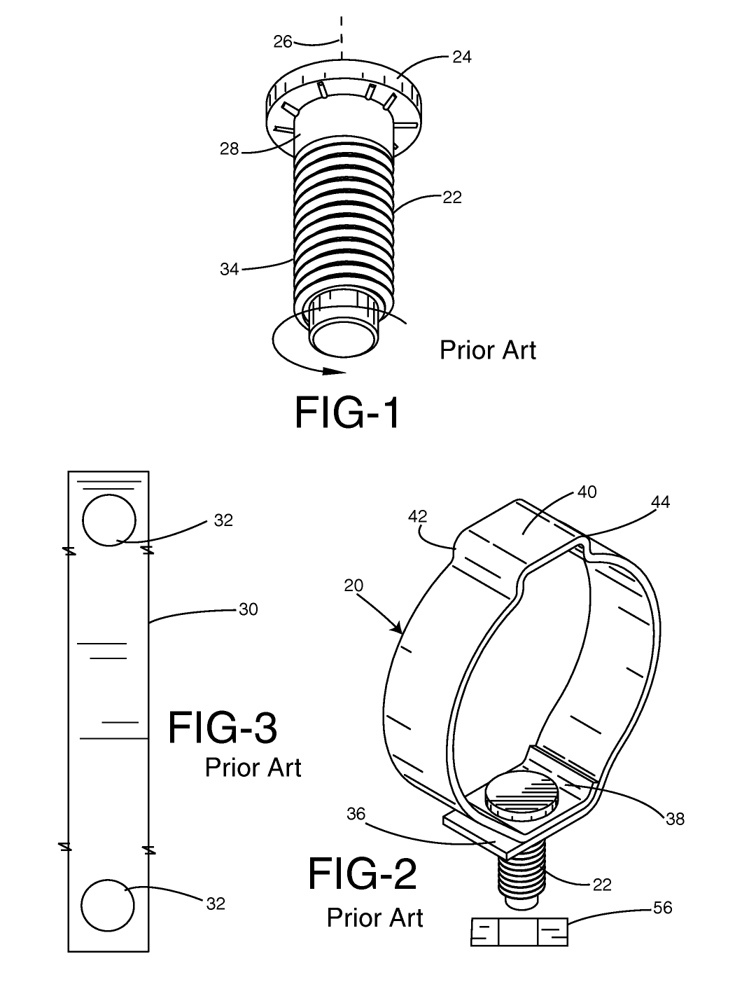

### DETAILED DESCRIPTION OF THE DRAWINGS

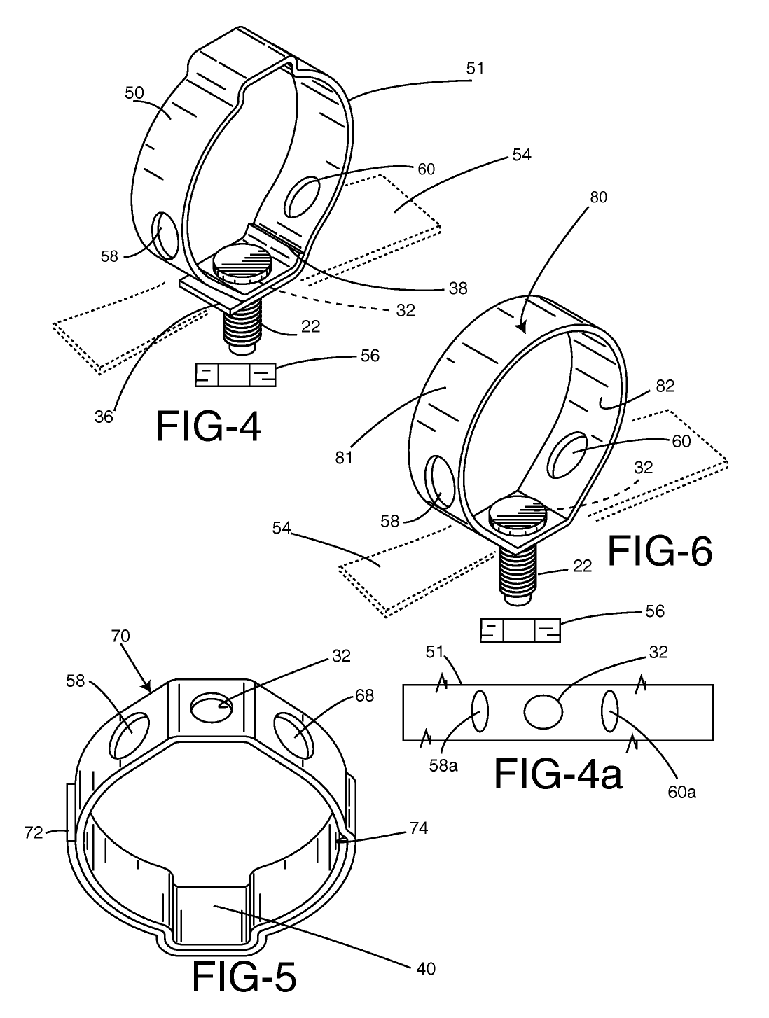

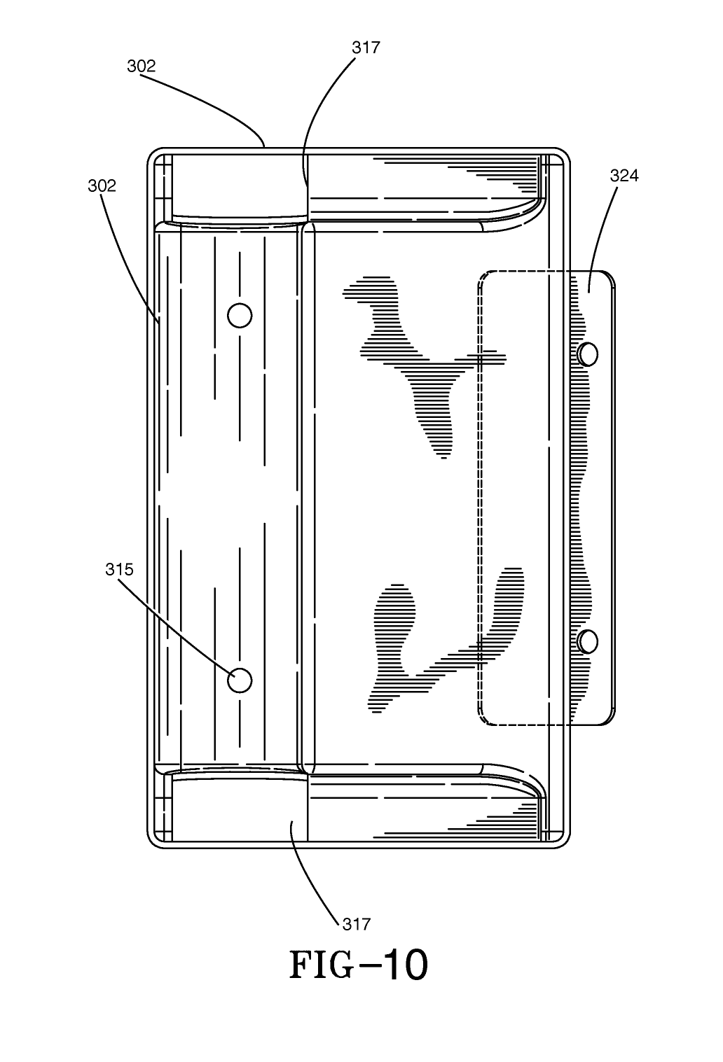

As mentioned, the present invention provides a band clamp with an increased torque-out resistance and solves the above stated deficiencies in the prior art through the addition of one or more side holes that absorb or divert stress within the band away from the fastener receiving opening. Reference is made to FIGS. 4, 5 and 6. In FIG. 4, band clamp 50 includes a metal band 51 that is formed into a loop with overlapping ends 36 and 38, each end having a fastener receiving opening 32. Band 50 is much the same as band 20 of FIG. 2. Fastener 22 is received within both openings 32; the fastener extends through a similar opening (see FIGS. 9 and 10) in a mounting surface, generally shown in phantom line as 54 and secured thereto by another fastener such as nut 56. Band clamp 50 includes two additional openings 58 and 60. To prevent the stresses generated throughout the band from enlarging opening 32, it is preferred that the diameter of openings 58 and 60 be larger than the diameter of opening 32. In the preferred embodiment the additional openings are circular; however, these openings can also be oblong. In FIG. 4a the major diameter of the oblong openings 58a and 60a is larger than the diameter of the fastener receiving opening 32.

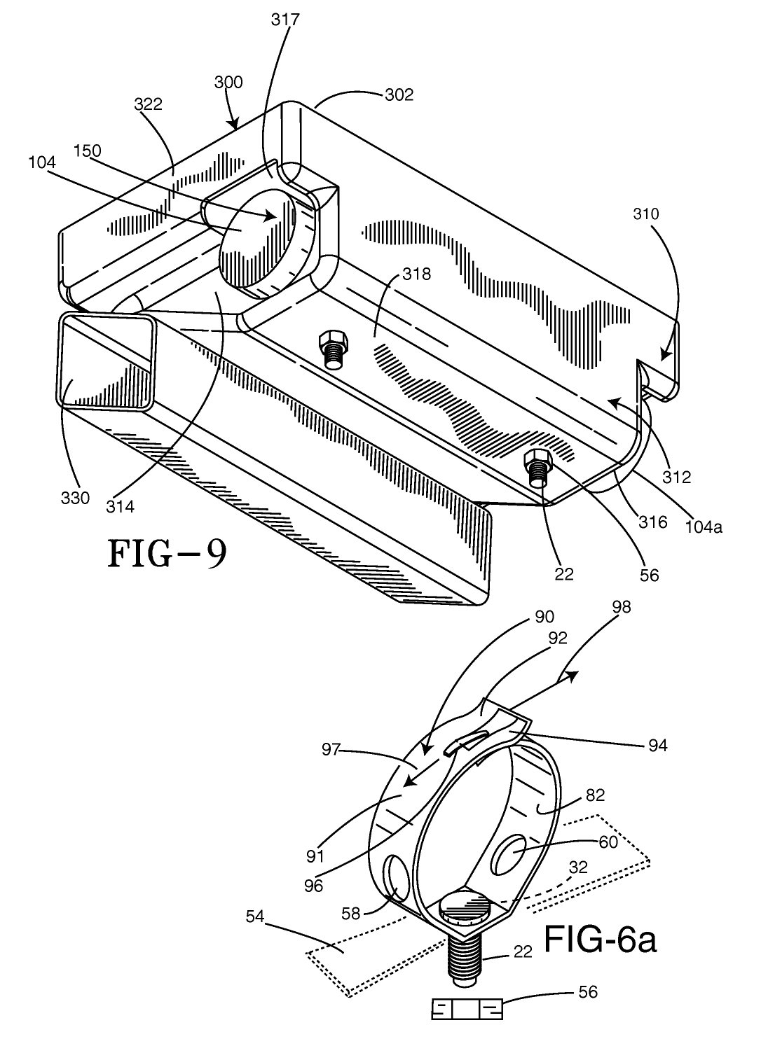

The band 70 shown in FIG. 5 also includes two overlapping ends 72 and 74; however, these ends are positioned opposite opening 32 and also form part of the projecting portion 40. In FIG. 6 the band clamp 80 has a metal band 81 formed as a single loop 82. The fastener 22 is received within a fastener receiving opening such as 32. Band 80 further includes the openings 58 and 60 positioned on either side of the fastener receiving opening 32. This band clamp 80 does not include a separate mechanism to tighten the band about the inflator albeit some tightening may occur when nut 56 secures the band clamp 80 to a module housing such as shown in FIGS. 9 and 10. Band clamp 80 is sized to tightly fit the exterior sides of a cylindrical inflator and when slipped thereon the friction forces therebetween are sufficient to hold the clamp to the inflator. FIG. 6a shows a band clamp 90 having a band 91 with interdigitating fingers 92, 94 and 96 at respective ends. After band 91 is fitted about the inflator, the fingers are pulled cross-wise (see arrows 97 and 98) to each other deforming band 91 and tightening the band 91 about the inflator.

In each of the above embodiments since the side holes 58 and 60 are larger in diameter than the central stud hole 32, each band when under tension will permit each side hole 58 and 60 (58a and 60a) to stretch or deform, leaving the central stud hole 32 essentially round.

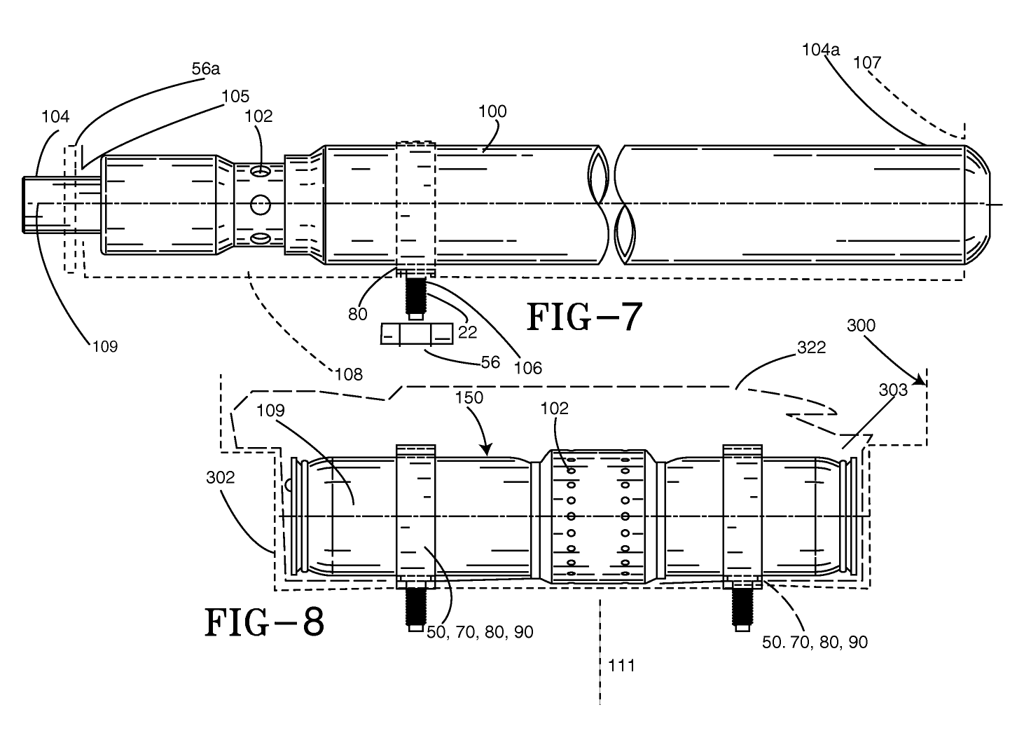

Another aspect of the invention is that it can be used to mount a variety of cylindrically shaped inflators including passenger, or side air bag or curtain, or knee air bag inflators to various mounting surfaces which are part of a housing. In FIG. 7 one band clamp 80 is used to mount an air bag inflator generally shown by 100 to housing 108. In this inflator 100 its exit ports 102 are positioned toward one of its ends 104. The band clamp 80 does not include a separate tightening mechanism but is sized to tightly fit (press-fit) about the exterior of inflator 100. End 104 of the inflator is first received in opening 105 in one side of the housing 108, however, end 104a of the inflator is held above its opening 107 and the fastener 22 is apart from the opening 106. The inflator is then manipulated so fastener 22 is received within an opening 106 of the housing 108 and inflator end 104a rests in slot 107. The fastener 22 is secured by a nut 56 preventing movement of the inflator perpendicular to axis 109. Movement of the inflator along axis 109 is prevented by another nut 56a secured about end 104a and which butts up against a side of the housing. FIG. 8 shows that two band clamps 50, 70, 80 or 90 can be used to secure a cylindrically shaped inflator 150 to a module housing. The exit ports 102 of inflator 150 are symmetrically located about a center portion of the inflator. The air bag module housing is shown in phantom line as numeral 302 (also shown in FIG. 9). Housing 302 includes an upper section 310 with the open mouth 303 and includes a lower section 312 with end side walls 314 and 316, and a bottom 318 shown in greater in FIG. 9. Each side wall 314 and 316 and a lower part of a peripheral wall 320 of the upper section 310 also includes a notch or groove 317 to receive a respective end 104, 104a of the inflator 150. The bottom includes small fastener receiving openings 315 to receive each stud or fastener 22, which extend from the band clamp 50, 70, 80 or 90. The inflator 150 and associated air bag 322, which the inflator is to inflate, are positioned at the mouth of the housing with studs 22 extending through the air bag. The inflator, air bag 322, and band clamps are moved together into the housing and the fasteners 22 perpendicular along axis 111 (which is perpendicular to inflator axis 109) into the openings 315 in a relatively simultaneous manner. The fasteners are secured by nuts 56.

In regard to the module housing 302, the lower section 312 has a width smaller than the length of the inflator. The sides of the lower section transition to an outwardly directed peripheral wall 322 of an upper section (wider than the length of the inflator). As can be seen the peripheral wall 320 is above and parallel to the end side walls 312 and 316 of the lower section 312. The notch 317 permits the inflator to be moved directly into the lower section 312 of the housing. The box-section 330 shown in FIG. 9 is representative of a mounting surface in a vehicle such as a pillar, a support beam under the instrument panel or a frame of a seat. By using the various band clamps of the present invention the inflator 150 can be moved along axis 111 that is perpendicular to the longitudinal axis 109 and generally simultaneously seated in the module housing 302.

Reference is briefly made to FIG. 10, which illustrates a plan view of housing 302. The extending flange 324 can be secured to the support beam 330.

Many changes and modifications in the above-described embodiment of the invention can, of course, be carried out without departing from the scope thereof. Accordingly, that scope is intended to be limited only by the scope of the appended claims.

1. A band clamp for securing an inflator of an air bag module to a mounting surface, the clamp having a band formed into a loop of diameter slightly larger than a diameter of the inflator enabling the band to be slipped over the inflator,
the band including a fastener receiving opening therethrough to receive a fastener which is receivable into the mounting surface, wherein stress in the band if uncompensated tends to enlarge the fastener receiving opening, the band clamp further including first means for absorbing the stress to lessen the possible enlargement of the fastener receiving opening.

2. The band clamp according to claim 1 including means for tightening the band about the inflator, such tightening creating stress within the band.

3. The band clamp according to claim 1 wherein the tightening means is located generally opposite the fastener receiving opening.

4. The band clamp according to claim 1 wherein the first means includes at least one opening located through the band adjacent a side of the fastener receiving opening.

5. The band clamp according to claim 4 wherein the at least one opening has a diameter larger than a diameter of the fastener receiving opening.

6. The band clamp according to claim 4 wherein the first means includes at least two openings, each opening located through the band adjacent a side of the fastener receiving opening.

7. The band clamp according to claim 6 wherein each opening of the at least two openings has a diameter larger than a diameter of the fastener receiving opening.

8. The band clamp according to claim 4 wherein the band includes two overlapping ends, wherein each end includes a fastener receiving opening and wherein a single fastener is received through both fastener receiving openings.

9. The band clamp according to claim 8 wherein the band includes an additional opening adjacent each fastener opening which is proximate an end of the band.

10. The band clamp according to claim 6 wherein each additional opening has a diameter larger than a diameter of the fastener receiving opening.

11. An air bag module comprising a cylindrically shaped inflator (150) having exit ports (102) centrally located relative to ends of the inflator, two band clamps (50, 70, 80, 90) located on opposing sides of the exit ports enveloping lateral cylindrical portions of the inflator, each of the band clamps including an extending threaded fastener, the module including a housing with an open mouth, the housing including a bottom opposite the open mouth, the bottom including fastener receiving openings, wherein the inflator, band clamps and housing are configured to permit the inflator to be inserted into the housing through the open mouth with the fasteners of the band clamps entering into a respective fastener receiving opening relatively simultaneously.

12. The device according to claim 11 wherein each band clamp includes a band formed into a loop of diameter slightly larger than a diameter of the inflator enabling the band to be slipped over the inflator,
the band including a band fastener receiving opening therethrough to receive a fastener which is receivable into the mounting surface, wherein stress in the band if uncompensated tends to enlarge the band fastener receiving opening, the band clamp further including first means for absorbing the stress to lessen the possible enlargement of the band fastener receiving opening.

13. The band clamp according to claim 12 including means for tightening the band about the inflator such tightening creating stress within the band.

14. The band clamp according to claim 11 wherein the first means includes at least one opening located through the band adjacent a side of the band fastener receiving opening.

15. An air bag module including an inflator, housing and band clamp for securing an inflator to a mounting surface of the housing, the clamp having a band formed into a loop of diameter slightly larger than a diameter of the inflator enabling the band to be slipped over the inflator,
the band including a fastener receiving opening therethrough to receive a fastener which is receivable into the mounting surface, wherein stress in the band if uncompensated tends to enlarge the fastener receiving opening, the band clamp further including first means for absorbing the stress to lessen the possible enlargement of the fastener receiving opening.

16. The module according to claim 1 including means for tightening the band about the inflator such tightening creating stress within the band.

17. The module according to claim 15 wherein the first means includes at least one opening located through the band adjacent a side of the fastener receiving opening.

18. The module according to claim 18 wherein the band clamp is configured to be press fit upon the inflator.
